(19) United States
(12) Patent Application Publication
(10) Pub. No.: US 2026/0158790 A1
(43) Pub. Date: Jun. 11, 2026

(54) INKJET RECORDING APPARATUS

(71) Applicant: KYOCERA Document Solutions Inc., Osaka (JP)

(72) Inventor: Takuma ARAKI, Osaka (JP)

(73) Assignee: KYOCERA Document Solutions Inc., Osaka (JP)

(21) Appl. No.: 19/395,656

(22) Filed: Nov. 20, 2025

(30) Foreign Application Priority Data
Dec. 5, 2024 (JP) 2024-212003

(51) Int. Cl. B41J 2/17; B41J 2/175; B41J 2/18; B41J 2/19

(52) U.S. Cl. CPC B41J 2/1707; B41J 2/17523; B41J 2/17596; B41J 2/18; B41J 2/19

(57) ABSTRACT

An inkjet recording apparatus includes a recording head, an ink container, an ink feed portion, a driving mechanism, a timer, a home position detection portion, and a control portion. The ink feed portion includes a subsidiary tank, an ink flow passage, and a syringe pump having a cylinder and a piston. When performing a purging operation using the syringe pump, the control portion performs a pressing operation by pressing the piston at the home position with a previously determined set pressing amount and then, using the timer, counts the movement time after starting a pulling operation until the piston reaches the home position. If the movement time is shorter than a threshold value, it is judged that a fault is present in the ink feed portion.

### INCORPORATION BY REFERENCE

This application is based on and claims the benefit of priority from Japanese Patent Application No. 2024-212003 filed on Dec. 5 2024, the contents of which are hereby incorporated by reference.

### BACKGROUND

The present disclosure relates to an inkjet recording apparatus.

Conventionally in an inkjet recording apparatus, such as an inkjet printer, a recording head provided with a pressurizing chamber filled with ink is used. This pressurizing chamber communicates with a nozzle, and when ink is loaded in the pressurizing chamber, a liquid surface (meniscus) forms inside the nozzle. A pressurizing element such as a piezoelectric element that deforms when a driving voltage is applied to it and an oscillating plate stacked on the pressurizing element to form a driving portion are connected to the pressurizing chamber. When the oscillating plate is deformed to reduce the volume of the pressurizing chamber, the ink in the pressurizing chamber is pressurized and ejected as ink droplets from the nozzle tip.

In such an inkjet recording apparatus, a method of supplying ink to the recording head using a syringe pump is well known. This configuration enables not only purging of ink out of the recording head, but also discharge of air bubbles by circulation, as well as replacement of ink with another liquid.

In the configuration using a syringe pump as described above, an excessive pressure may be applied to the syringe and the flow passage when ink is pushed out by a piston in the syringe pump. This can occur due to causes such as a runaway of a motor driving the syringe pump, a bend or clog in an ink supply tube, or failure to insert a joint component in the ink flow passage. As a result, an excessive pressure may be applied to the syringe pump, the ink flow passage, and, in some cases, the recording head. In the worst case, this could lead to ink contamination both inside and outside the apparatus resulting from failure of the syringe pump or rupture of the ink supply tube.

### SUMMARY

According to one aspect of the present disclosure, an inkjet recording apparatus includes a recording head, an ink container, an ink feed portion, a driving mechanism, a timer, a home position detection portion, and a control portion. The recording head has a plurality of nozzles for ejecting ink. The ink container stores ink. The ink feed portion includes a subsidiary tank that temporarily stores the ink fed from the ink container, an ink flow passage through which the ink circulates from the subsidiary tank through the recording head to the subsidiary tank, and a syringe pump disposed downstream of the subsidiary tank, upstream of the recording head with respect to the ink flow direction in the ink flow passage. The syringe pump includes a cylinder that has at one end a discharge port coupled to the recording head and a loading port coupled to the subsidiary tank and that is open at the other end. The syringe pump further includes a piston fitted in the cylinder so as to be movable in one direction toward the one end and in the other direction toward the other end. The driving mechanism performs a pressing operation to move the piston toward the one end and a pulling operation to move it toward the other end. The timer counts the movement time of the piston. The home position detection portion detects the piston being at the home position. The control portion controls the driving mechanism. The driving mechanism has a motor, one or more gears that transmit the driving force of the motor to the piston, and a torque limiter mounted on one of the gears. When performing a purging operation to forcibly expel ink from the nozzles of the recording head using the syringe pump, the control portion can execute a fault check mode that performs the pressing operation by pressing the piston at the home position with a previously determined set pressing amount and then, using the timer, counts the movement time after starting the pulling operation until the piston reaches the home position. If the movement time is shorter than a threshold value, the control portion detects a fault in the ink feed portion.

### BRIEF DESCRIPTION OF THE DRAWINGS

FIG. 1 is a sectional view showing a schematic configuration of an inkjet recording apparatus according to one embodiment of the present disclosure.

FIG. 2 is a plan view around a recording portion in the inkjet recording apparatus of this embodiment.

FIG. 3 is a block diagram showing a hardware configuration of a principal portion of the inkjet recording apparatus of this embodiment.

FIG. 4 is an explanatory diagram showing a configuration of an ink feed portion in the inkjet recording apparatus of this embodiment.

FIG. 5 is an explanatory diagram of a syringe pump and a driving mechanism, showing the operation observed when ink is discharged from the syringe pump.

FIG. 6 is an explanatory diagram of the syringe pump and the driving mechanism, showing the operation observed when ink is loaded into the syringe pump.

FIG. 7 is a flowchart showing an example of the control for executing a fault check mode for the ink feed portion in the inkjet recording apparatus of this embodiment.

### DETAILED DESCRIPTION

### 1. Configuration of an Inkjet Recording Apparatus

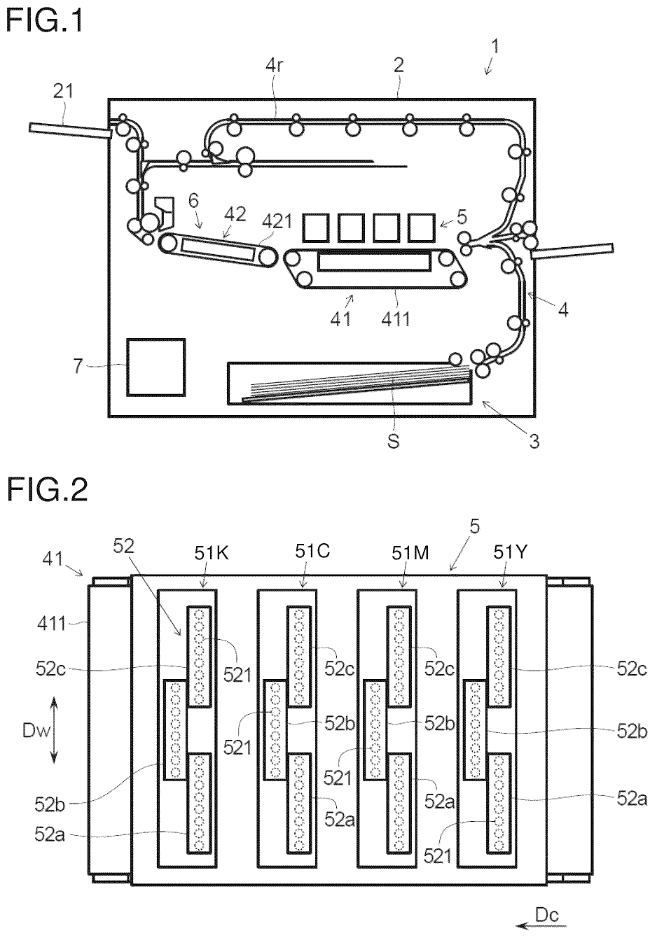

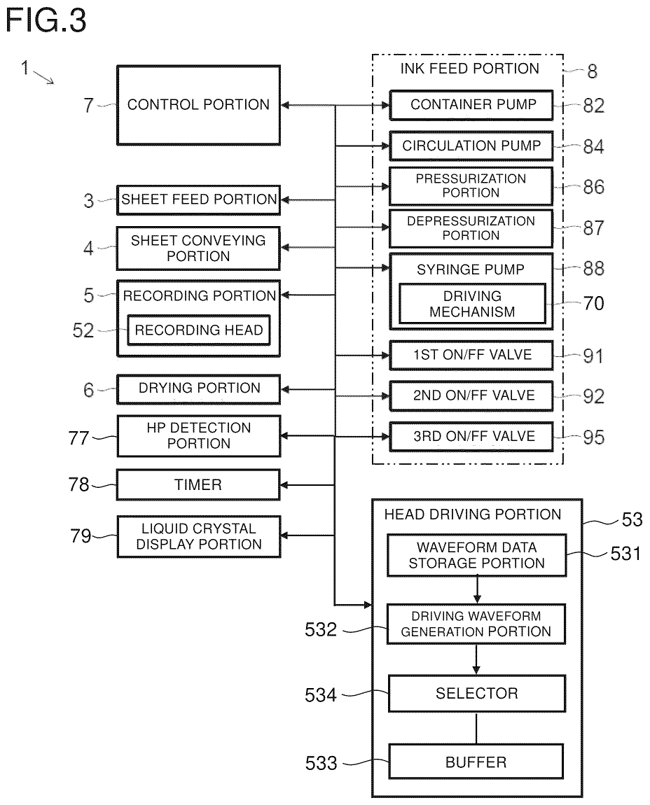

An embodiment of the present disclosure will be described below with reference to the accompanying drawings. FIG. 1 is a sectional view showing a schematic configuration of an inkjet recording apparatus 1 according to one embodiment of the present disclosure. FIG. 2 is a plan view around a recording portion 5 of the inkjet recording apparatus 1 in FIG. 1. FIG. 3 is a block diagram showing a hardware configuration of a principal portion of the inkjet recording apparatus 1 in FIG. 1. The inkjet recording apparatus 1 is, for example, an inkjet printer, and includes a body 2, a sheet feed portion 3, a sheet conveying portion 4, a recording portion 5, a drying portion 6, and a control portion 7.

The sheet feed portion 3 is disposed, for example, in a lower part of the body 2. The sheet feed portion 3 stores a plurality of sheets (recording medium) S and separates and feeds them out one sheet at a time during recording.

The sheet conveying portion 4 is disposed downstream (upper part in FIG. 1) of the sheet feed portion 3 with respect to the sheet conveying direction and conveys the sheet S fed out from the sheet feed portion 3. The sheet conveying portion 4 conveys the sheet S to the recording portion 5 and the drying portion 6, and then discharges the sheet S after recording and drying to a sheet discharge portion 21. The sheet conveying portion 4 includes, for example, a reversing conveying portion 4r. In the case of two-side recording, the sheet conveying portion 4 diverts the sheet S after recording and drying on the first side, to the reversing conveying portion 4r. It then switches the conveying direction to reverse the front and back sides of the sheet S, and conveys the sheet S, with the second side facing up, back to the recording portion 5 and the drying portion 6.

The sheet conveying portion 4 includes a first belt conveying portion 41 and a second belt conveying portion 42. The first belt conveying portion 41 has a first conveyor belt 411 formed in an endless shape. The second conveying portion 42 has a second conveyor belt 421 formed in an endless shape. The first and second belt conveying portions 41 and 42 convey the sheet S while holding it by suction on upper surfaces (conveying surfaces) of the first and second conveying belts 411 and 421, respectively, which are stretched over a plurality of rollers including a driving roller. The first belt conveying portion 41 is disposed below the recording portion 5 and conveys the sheet S. The second belt conveying portion 42 is arranged downstream (to the left in FIG. 1) of the first belt conveying portion 41 with respect to the sheet conveying direction and is disposed in the drying portion 6 to convey the sheet S.

The recording portion 5 is disposed downstream of the sheet feed portion 3 with respect to the sheet conveying direction above the first belt conveying portion 41. The recording portion 5 is disposed above the first conveying belt 411 at a predetermined interval from it so as to face the sheet S. That is, the recording portion 5 faces the sheet S, conveyed by the sheet conveying portion 4 while being held by suction on the upper surface of the first conveying belt 411.

As shown in FIG. 2, the recording portion 5 holds head units 51Y, 51M, 51C, and 51K corresponding to the four colors of yellow, magenta, cyan, and black, respectively. The head units 51Y, 51M, 51C, and 51K are disposed side by side along the sheet conveying direction Dc such that their longitudinal direction is parallel to the sheet width direction Dw, which is orthogonal to the sheet conveying direction Dc. Since the four head units 51Y, 51M, 51C, and 51K share the same basic configuration, the suffixes “B”, “C”, “M”, and “Y” for the different colors may be omitted unless distinction is necessary in the following descriptions.

The head unit 51 of each color has a line-head type recording head 52. The recording head 52, in the head unit 51 of each color, a plurality of recording heads (in this embodiment, three recording heads, 52a, 52b, and 52c) are arranged in a staggered pattern along the sheet width direction Dw.

The recording head 52 has a plurality of ink ejection nozzles 521 on its bottom face. The plurality of ink ejection nozzles 521 are arranged along the sheet width direction Dw and can eject ink across the entire recording area on the sheet S. The recording portion 5 ejects ink from the respective recording heads 52 of the four color head units 51Y, 51M, 51C, and 51K sequentially to the sheet S conveyed by the first conveying belt 411 to record a full color image or a monochrome image on the sheet S.

The drying portion 6 is disposed downstream of the recording portion 5 with respect to the sheet conveying direction, and is provided with the second belt conveying portion 42. The sheet S having an ink image recorded in the recording portion 5 is conveyed in the drying portion 6 while being held by suction on the second conveying belt 421. Meanwhile, the ink dries.

The control portion 7 includes a CPU, a storage portion, and other electronic circuits and electronic components (of which none is illustrated). The CPU controls the operation of different components provided in the inkjet recording apparatus 1 based on control programs and data stored in the storage portion to perform processes related to the functions of the inkjet recording apparatus 1. The sheet feed portion 3, the sheet conveying portion 4, the recording portion 5, and the drying portion 6 each individually receive control signals from the control portion 7 and operate in coordination to perform recording on the sheet S. The storage portion is configured, for example, as a combination of a non-volatile storage device such as a program ROM (read-only memory) and a data ROM, and a volatile storage device, such as a RAM (random-access memory).

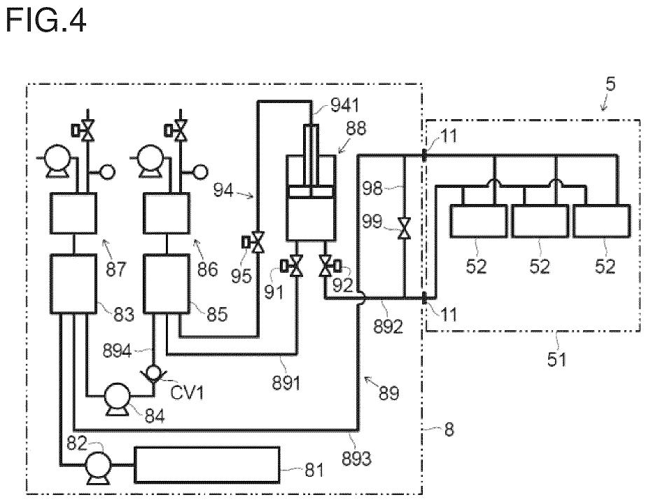

As shown in FIG. 3, the inkjet recording apparatus 1 includes an ink feed portion 8 and a head driving portion 53. The ink feed portion 8 includes a container pump 82, a circulation pump 84, a pressurization portion 86, a depressurization portion 87, a syringe pump 88, a first on-off valve 91, a second on-off valve 92, and a third on-off valve 95. The ink feed portion 8 further includes an ink container 81, a first subsidiary tank 83, a second subsidiary tank 85, a first flow passage 89, a second flow passage 94, a third flow passage 98, and an on-off mechanism 99 (all shown in FIG. 4). The configuration of the ink feed portion 8 will be described in detail later.

The head driving portion 53 has a waveform data storage portion 531, a driving waveform generation portion 532, a buffer 533, and a selector 534. The waveform data storage portion 531 stores driving waveform data for driving the pressurizing element (not illustrated) in the recording head 52.

The driving waveform generation portion 532 generates a driving waveform (driving voltage) for driving the pressurizing element in the recording head 52, based on the driving waveform data stored in the waveform data storage portion 531. The buffer 533 stores driving waveform selection data corresponding to a one-page image to be recorded on the sheet S. The selector 534, based on the one-page driving waveform selection data stored in the buffer 533, either applies the driving voltage with the ejection driving waveform to the pressurizing element in the recording head 52 or performs an operation to keep the driving voltage for the pressurizing element in the recording head 52 constant without selecting the driving waveform.

### 2. Configuration of an Ink Feed Portion

FIG. 4 is an explanatory diagram showing the configuration of the ink feed portion 8 in the inkjet recording apparatus 1 in FIG. 1. With reference to FIGS. 3 and 4, the ink feed portion 8 in the inkjet recording apparatus 1 will be described. The ink feed portion 8 is provided one for each of the four head units 51. In the following description, the suffixes for different colors are omitted. The ink feed portion 8 and the head unit 51 are coupled together by a removable coupling 11. The coupling 11 incorporates a valve member (not illustrated) which opens the ink flow passage in a connected state and closes it in a disconnected state.

The ink container 81 is removably mounted in the body 2. The ink container 81 stores the ink fed to the recording head 52.

The container pump 82 is disposed downstream of the ink container 81 with respect to the ink flow direction. The container pump 82 sucks the ink from the ink container 81 and ejects it toward the first subsidiary tank 83. The operation of the container pump 82 is controlled by the control portion 7.

The first subsidiary tank 83 is disposed downstream of the container pump 82 with respect to the ink flow direction. The first subsidiary tank 83 temporarily stores the ink fed from the ink container 81. The first subsidiary tank 83 is provided with an ink level sensor (not illustrated). The ink level sensor can be, for example, any of optical, capacitive, electrode, differential pressure, and float-type sensors, and detects the ink level in the first subsidiary tank 83.

The control portion 7 receives a detection signal from the ink level sensor of the first subsidiary tank 83. When the ink level in the first subsidiary tank 83 detected by the ink level sensor falls below a predetermined value, the control portion 7 controls the container pump 82 to feed ink from the ink container 81 to the first subsidiary tank 83. The amount of ink fed from the ink container 81 to the first subsidiary tank 83 is controlled, for example, by adjusting the driving time of the container pump 82. If, after the predetermined driving time of the container pump 82 elapses, the ink level in the first subsidiary tank 83 detected by the ink level sensor does not reach the predetermined value, the control portion 7 determines that the ink container 81 is empty.

The circulation pump 84 is disposed downstream of the first subsidiary tank 83 in the ink flow direction. The circulation pump 84 moves ink from the first subsidiary tank 83 to the second subsidiary tank 85. The circulation pump 84 may be selected from liquid pumps such as tube pumps and diaphragm pumps. The operation of the circulation pump 84 is controlled by the control portion 7.

The second subsidiary tank 85 is disposed downstream of the circulation pump 84 in the ink flow direction. The second subsidiary tank 85 temporarily stores the ink fed from the first subsidiary tank 83. Like the first subsidiary tank 83, the second subsidiary tank 85 is provided with an ink level sensor (not illustrated), which detects the ink level in the second subsidiary tank 85.

The control portion 7 receives a detection signal from the ink level sensor of the second subsidiary tank 85. When the ink level in the second subsidiary tank 85 detected by the ink level sensor falls below a predetermined value, the control portion 7 controls the circulation pump 84 to move ink from the first subsidiary tank 83 to the second subsidiary tank 85. The amount of ink fed from the first subsidiary tank 83 to the second subsidiary tank 85 is controlled, for example, by adjusting the driving time of the circulation pump 84.

The pressurization portion 86 is provided adjacent to the second subsidiary tank 85. The pressurization portion 86 pressurizes the interior of the second subsidiary tank 85 to feed ink from the second subsidiary tank 85 to the recording head 52. The operation of the pressurization portion 86 is controlled by the control portion 7.

The depressurization portion 87 is provided adjacent to the first subsidiary tank 83. The depressurization portion 87 depressurizes the interior of the first subsidiary tank 83 to circulate ink from the recording head 52 to the first subsidiary tank 83. The operation of the depressurization portion 87 is controlled by the control portion 7.

The syringe pump 88 is disposed downstream of the second subsidiary tank 85, upstream of the recording head 52, with respect to the ink flow direction. Ink flows from the second subsidiary tank 85 into the syringe pump 88 and flows out of it toward the recording head 52.

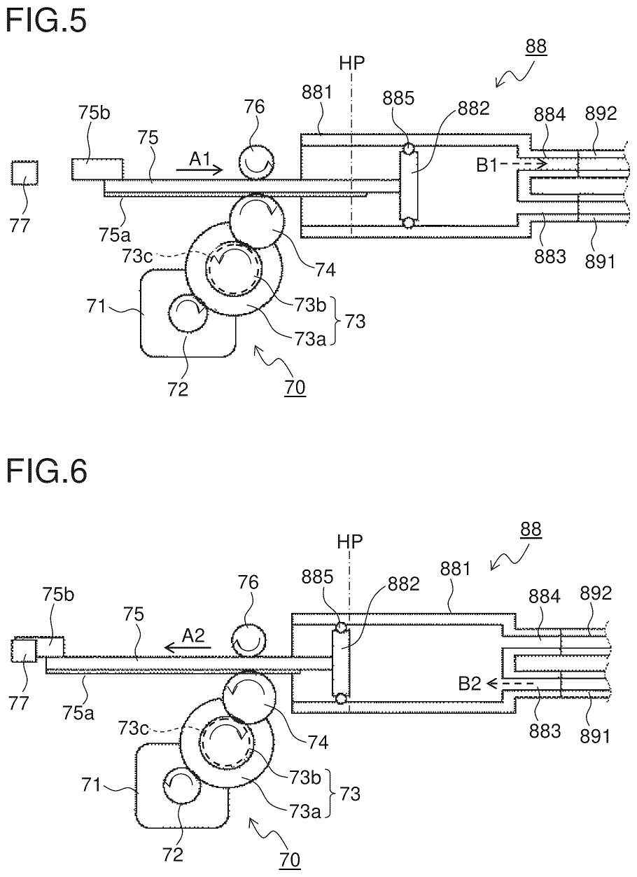

When an image is recorded on the sheet S, a recording pressure is applied to the ink by the pressurization portion 86. In contrast, for example, during maintenance, the control portion 7 can apply a maintenance pressure higher than the recording pressure to the ink by moving downward a piston 882 (see FIG. 5) in the syringe pump 88 using a driving mechanism 70 (see FIG. 3) and thereby expelling the ink out of the syringe pump 88. That is, the syringe pump 88 can apply the maintenance pressure higher than the recording pressure applied by the pressurization portion 86 to the ink.

The first flow passage 89 is an ink flow passage through which ink circulates from the first subsidiary tank 83 through the circulation pump 84, the second subsidiary tank 85, the syringe pump 88, and the recording head 52 to the first subsidiary tank 83. The first flow passage 89 includes a first conduit 891 extending from the second subsidiary tank 85 to the syringe pump 88, a second conduit 892 extending from the syringe pump 88 to the recording head 52, a third conduit 893 extending from the recording head 52 to the first subsidiary tank 83, and a fourth conduit 894 extending from the first subsidiary tank 83 to the second subsidiary tank 85. A non-return valve CV1 is disposed in the fourth conduit 894. The non-return valve CV1 prevents the ink from flowing backward in the first flow passage 89 from downstream to upstream with respect to the ink flow direction.

With no image recording underway, the control portion 7 can execute a forced circulation mode, in which the syringe pump 88 applies the maintenance pressure to the ink to force it to flow downstream of the syringe pump 88 in the ink flow direction. In this way, while no image recording is underway, bubbles in the first flow passage 89, which is an ink flow passage, can be moved away from the recording head 52 so that, during image recording on the sheet S, bubbles in the first flow passage 89 can be prevented from reaching the recording head 52.

Furthermore, with no image recording underway, the control portion 7 can execute a cleaning mode, in which it forcibly ejects (purges) ink through the ink ejection nozzle 521 (see FIG. 2) to clean the recording head 52. In the cleaning mode, ink is ejected from the ink ejection nozzle 521 of the recording head 52 to the ink ejection surface. The ejected ink contains, for example, the ink with increased viscosity, foreign matter, and the like in the ink ejection nozzle 521, and is held on the ink ejection surface by surface tension. The ink on the ink ejection surface is then wiped off by a wiper (not illustrated) or the like.

The ink feed portion 8 is provided with the first on-off valve 91, the second on-off valve 92, the second flow passage 94, the third on-off valve 95, the third flow passage 98, and the on-off mechanism 99. The first on-off valve 91 is disposed in the first flow conduit 891 of the first flow passage 89, upstream of the syringe pump 88 with respect to the ink flow direction. The first on-off valve 91 opens and closes the first flow passage 89 between the second subsidiary tank 85 and the syringe pump 88.

The second on-off valve 92 is disposed in the second conduit 892 of the first flow passage 89. The second on-off valve 92 opens and closes the first flow passage 89 between the syringe pump 88 and the recording head 52. The third on-off valve 95 is disposed in a fifth conduit 941 of the second flow passage 94. The third on-off valve opens and closes the second flow passage 94.

The on-off mechanism 99 is disposed in the third flow passage 98. The on-off mechanism 99 is configured, for example, as a clamp which allows the third flow passage 98 to be opened and closed manually. The on-off mechanism 99 opens and closes the third flow passage 98.

### 3. Configuration of a Syringe Pump

FIGS. 5 and 6 are explanatory diagrams of the syringe pump 88 and the driving mechanism 70, showing the operation observed when ink is discharged from the syringe pump 88 and ink is loaded into it, respectively. With reference to FIGS. 5 and 6, the configuration of the syringe pump 88 and the driving mechanism 70 will be described in detail.

As shown in FIGS. 5 and 6, the syringe pump 88 includes a cylindrically formed cylinder 881 (housing) and a disc-formed piston 882 (pressing portion). At one end side (right side in FIG. 5) of the cylinder 881, there are provided a loading port 883 (loading inlet) connected to the second subsidiary tank 85 (see FIG. 4) via the first conduit 891 and a discharge port 884 (discharge outlet) connected to the recording head 52 (see FIG. 4) via the second conduit 892. The other end side (left side in FIG. 5) of the cylinder 881 is open to allow the piston 882 to be inserted into it.

The piston 882 is reciprocatably fitted in the cylinder 881. An O-ring 885 is fitted between the outer circumferential surface of the piston 882 and the inner circumferential surface of the cylinder 881. The O-ring 885 seals the space enclosed by the piston 882 and the cylinder 881.

In the following description, the direction in which the piston 882 moves toward the side of the cylinder 881 where it has the loading port 883 and the discharge port 884 (i.e., one end side, right side in FIG. 5) is referred to as an advancing direction and the direction in which the piston 882 moves toward the open side of the cylinder 881 (i.e., the other end side, left side in FIG. 5) is referred to as a receding direction. A home position HP, which serves as the reference position for the reciprocating motion of the piston 882, is set near the open side of the cylinder 881. The home position HP is the position where the piston 882 is moved maximally to the receding direction (maximum tension position).

The driving mechanism 70 includes a motor 71, a pinion gear 72, an idle gear 73, a driving output gear 74, a rack portion 75, and a roller 76.

The motor 71 generates a driving force under the control of the control portion 7 (see FIG. 3). The pinion gear 72 is fixed to the rotation shaft (driving output shaft) of the motor 71.

The idle gear 73 is provided between the pinion gear 72 and the driving output gear 74. The idle gear 73 is a double gear that has a large diameter portion 73a and a small diameter portion 73b coaxially. The large diameter portion 73a of the idle gear 73 meshes with the pinion gear 72. The small diameter portion 73b of the idle gear 73 meshes with the driving output gear 74.

The idle gear 73 incorporates a torque limiter 73c. Accordingly, if a load exceeding a certain level is applied between the large diameter portion 73a and the small diameter portion 73b, these rotate idly.

The driving output gear 74 is provided below the rack portion 75. The roller 76 is provided above the driving output gear 74 across the rack portion 75. That is, the driving output gear 74 and the roller 76 hold the rack portion 75 from above and below, respectively.

The rack portion 75 has the shape of a bar extending along the movement direction of the piston 882. One end of the rack portion 75 (the end at the advancing direction side) is fixed to the piston 882. In a bottom part of the rack portion 75, a rack gear 75a is provided along the longitudinal direction (the movement direction of the piston 882). The rack gear 75a meshes with the driving output gear 74. The piston 882 reciprocatably moves as the rack portion 75 moves in the advancing and receding directions. On the other end of the rack portion 75 (the end at the receding direction side) a detected portion 75b is formed.

A home position detection portion 77 is provided at the receding direction side of the rack portion 75. The home position detection portion 77 is configured, for example, with a PI (photo interrupter) sensor. As shown in FIG. 5, when the piston 882 is positioned forward of the home position HP in the advancing direction, the detected portion 75b of the rack portion 75 is located away from the home position detection portion 77. In this state, the detection signal from the home position detection portion 77 is in a high state.

When the piston 882 moves in the receding direction from the state in FIG. 5 and reaches the home position HP, the detected portion 75b of the rack portion 75 blocks light to the home position detection portion 77 as shown in FIG. 6. This switches the detection signal from the home position detection portion 77 from a high to low state. Based on the change in the detection signal from the home position detection portion 77, the control portion 7 detects the piston 882 having reached the home position HP.

Next, the operation of feeding ink to the recording head 52 by the syringe pump 88 will be described. To purge the recording head 52, with the second on-off valve 92 (see FIG. 4) open, the first on-off valve 91 (see FIG. 4) is closed. Then, as shown in FIG. 5, the motor 71 is driven in the forward rotation direction (clockwise in FIG. 5). This transmits the driving force of the motor 71 to the rack portion 75 via the pinion gear 72, the idle gear 73, and the driving output gear 74 and makes the rack portion 75 move in the advancing direction (direction of arrow A1 in FIG. 5).

As the rack portion 75 moves in the advancing direction, the piston 882 of the syringe pump 88 slides in the advancing direction in the cylinder 881, pressing the ink in the cylinder 881. The first conduit 891 connected to the loading port 883 of the cylinder 881 stays closed by the first on-off valve 91. On the other hand, the second conduit 892 connected to the discharge port 884 of the cylinder 881 is left open by the second on-off valve 92.

Thus, the ink pressed in the cylinder 881 is fed to the recording head 52 through the discharge port 884 and the second conduit 892 (indicated by arrow B1 in FIG. 5). In the recording head 52, the pressurized ink expels foreign matter and air bubbles in the recording head 52 (nozzle) through the ink ejection nozzle 521.

To reload the ink in the syringe pump 88, which decreases as the recording head 52 is purged, the first on-off valve 91 is switched to the open state and the second on-off valve 92 is switched to the closed state. As shown in FIG. 6, the motor 71 is driven in the reverse rotation direction (counterclockwise in FIG. 6). At this time, the driving force of the motor 71 is transmitted to the rack portion 75 via the pinion gear 72, the idle gear 73, and the driving output gear 74, and makes the rack portion 75 move in the receding direction (direction of arrow A2 in FIG. 6).

As the rack portion 75 moves in the receding direction, the piston 882 of the syringe pump 88 slides in the receding direction in the cylinder 881 to depressurize the inside of the cylinder 881. At this time, the second conduit 892 connected to the discharge port 884 of the cylinder 881 stays closed by the second on-off valve 92. On the other hand, the first conduit 891 connected to the loading port 883 of the cylinder 881 is left open by the first on-off valve 91.

Thus, as the pressure in the cylinder 881 decreases, the ink in the second subsidiary tank 85 is sucked into the cylinder 881 through the first conduit 891 and the loading port 883 (illustrated by arrow B2 in FIG. 6). Then, as the rack portion 75 moves in the receding direction, the detected portion 75b fitted to the rack portion 75 blocks light to the home position detection portion 77 to switch the detection signal. When the control portion 7 detects the piston 882 having reached the home position HP, it stops the reverse rotation driving of the motor 71.

### 4. Fault Detection Control for an Ink Feed Portion

Next, fault detection control for the ink feed portion 8 will be described as the distinctive feature of the embodiment. In the inkjet recording apparatus 1 of this embodiment, faults in the ink feed portion 8 are detected based on the operation of the syringe pump 88 to discharge and load ink. More specifically, from the state where the piston 882 is in the home position HP (see FIG. 6), the piston 882 is pressed (moved in the advancing direction) to discharge the ink in the syringe 881. Then, the time is counted after the piston 882 starts a pulling operation (movement in the receding direction) until it reaches the home position HP (until ink is loaded into the syringe 881).

As described above, the idle gear 73 in the driving mechanism 70 incorporates a torque limiter 73c. When a fault such as a bend or clog occurs in the first flow passage 89 (in particular, the second conduit 892) in the ink feed portion 8, or when a clog due to dried ink occurs in the ink ejection nozzle 521 of the recording head 52, the load applied to the idle gear 73 when pressing the piston 882 to discharge ink becomes higher than normal. And when the load exceeds a certain level, the torque limiter 73c activates.

When the torque limiter 73c activates, the idle gear 73 rotates idly and thus the pressing amount of the piston 882 (movement distance in the advancing direction) becomes smaller than the set value. When the pressing amount of the piston 882 becomes smaller, the time required for it to reach the home position HP by the pulling operation for the piston 882 becomes accordingly shorter than the standard time ((the set value of the pressing amount)/(the pulling speed)). That is, if the movement time is shorter than the standard time by a certain time or more, it is possible to detect a fault being present in the ink feed portion 8.

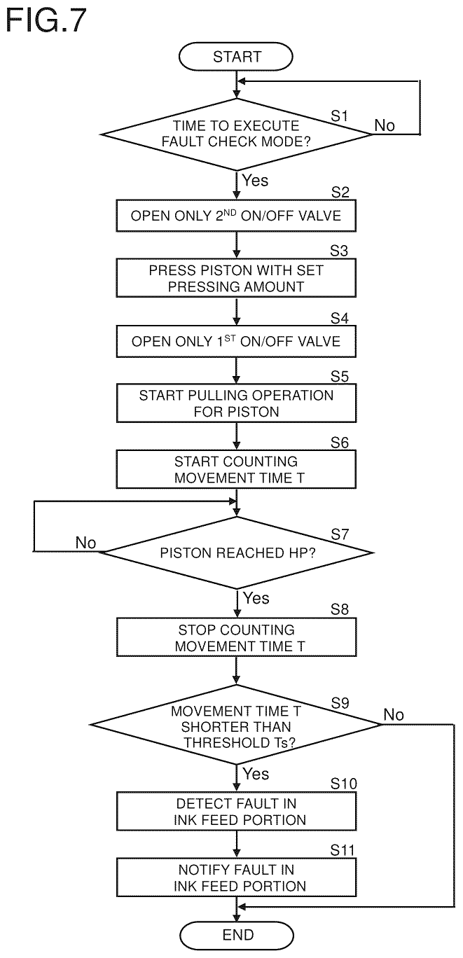

FIG. 7 is a flowchart showing an example of the control for executing a fault check mode for the ink feed portion 8 in the inkjet recording apparatus 1 of this embodiment. With reference to FIGS. 1 to 6 as needed, a description will be given of the procedure for executing the fault check mode when a purging operation is performed, along the steps in FIG. 7. Before the fault check mode is executed, the piston 882 is disposed at the home position HP.

First, the control portion 7 checks whether it is time to execute the fault check mode (step S1). The time to execute the fault check mode can be when the purging operation is performed immediately after the replacement or maintenance of the ink feed portion 8 or the recording head 52. This is intended to detect a fault such as an improper or failed connection in the ink flow passage during part replacement.

The fault check mode can be executed also when an initial purging operation is performed after the inkjet recording apparatus 1 has been left unused for a long period. When the inkjet recording apparatus 1 is left unused for a long period, ink near the ink ejection nozzle 521 of the recording head 52 may dry out and this could cause a significant load when ink is fed to the recording head 52.

If it is the time to execute the fault check mode (step S1: Yes), the control portion 7 opens only the second on-off valve 92 and closes the first and third on-off valves 91 and 95 (step S2).

Next, the control portion 7 transmits a control signal to the motor 71 and presses the piston 882 at the home position HP with a previously determined pressing amount (set pressing amount) (step S3). The set pressing amount is the same as the pressing amount for the purging operation. The amount of ejected ink required for cleaning the recording head 52 varies depending on the usage conditions of the inkjet recording apparatus 1, such as the idle time elapsed since the last printing operation. Accordingly, the pressing amount (set pressing amount) of the piston 882 for the purging operation also varies depending on the time to perform the purging operation. The set pressing amount can be adjusted with the number of driving pulses when the motor 71 is a stepper motor or with the driving time (power-on time) when the motor 71 is a brushed motor or brushless motor.

Next, the control portion 7 opens only the first on-off valve 91 and closes the second and third on-off valves 92 and 95 (step S4). Then, the control portion 7 transmits a control signal to the motor 71 to start the pulling operation for the piston 882(step S5). At the same time, the control portion 7 starts counting the movement time T with a timer 78 (see FIG. 3) (step S6).

Next, the control portion 7 checks whether the piston 882 has reached the home position HP (step 6). More specifically, the control portion 7 checks whether the detection signal has switched from the high to low state as a result of the detected portion 75b of the rack portion 75 blocking light to the home position detection portion 77. When the piston 882 reaches the home position HP (step S7: Yes), the control portion 7 ends counting the movement time T by timer 78 (step S8).

Next, the control portion 7 checks whether the movement time T counted in steps S6 to S8 is shorter than a threshold value Ts (step S9). The threshold value Ts is the minimum time required for the pulling operation for the piston 882 (its movement from the pressing position to HP). The threshold value Ts is calculated using the following equation (1).

Ts[sec]=(Set pressing amount [mL]/Pulling speed [mL per sec]×k (1)

As equation (1) shows, the threshold value Ts is determined by calculating the ratio relative to the original completion time for the pulling operation (i.e., (Set Pressing Amount)/(Pulling Speed)). The symbol k represents a coefficient that determines the ratio and, for example, when the threshold value is set to 50% of the original completion time for the pulling operation, k equals 0.5.

If the movement time T is shorter than the threshold value Ts (step S9: Yes), it suggests that, as a result of a load exceeding a certain level acting on the idle gear 73, the torque limiter 73c has activated to let the idle gear 73 rotate idly, making the pressing amount of the piston 882 smaller than the set value.

At this time, the control portion 7 judges that a fault is present in the ink feed portion 8 (step S10). Then, the control portion 7 notifies the user of the fault in the ink feed portion 8 (step S11). For example, a liquid crystal display portion 79 (notifying portion, see FIG. 3) indicates the presence and the location of the fault in the ink feed portion 8.

If the movement time T is longer than the threshold value Ts (step S9: No), the control portion 7 judges that no fault is present in the ink feed portion 8 and terminates the fault check mode.

According to the example of control in FIG. 7, it is possible to detect a fault in the ink feed portion 8 only with the existing components, that is, the torque limiter 73c, the home position detection portion 77, and the timer 78, without adding any components for detecting the fault in the ink feed portion 8. By detecting the fault based on the time required for the piston 882 to return to the home position HP, it is possible to detect the fault in all the ink flow passages downstream of the syringe pump 88 and thereby prevent an excessive pressure from being applied to the recording head 52.

The set pressing amount of the piston 882 and the threshold value Ts for checking for a fault can be adjusted by the control portion 7 and thus can be modified as needed based on the usage environment and operating time of the inkjet recording apparatus 1. As mentioned earlier, since the threshold value Ts is determined by calculating the ratio relative to the original completion time for the pulling operation ((Set Pressing Amount)/(Pulling Speed)), even if the set pressing amount of the piston 882 is changed, it is possible to determine easily an appropriate threshold value Ts corresponding to the set pressing amount.

According to the example of control in FIG. 7, if the movement time T is shorter than the threshold value Ts, it is immediately judged that a fault is present in the ink feed portion 8. However, to prevent false judgements, it is also possible to proceed as follows: even if the movement time T is shorter than the threshold value Ts, it is not immediately judged that a fault is present; instead, only if, when the purging operation is performed the next time and the fault check mode is executed again, the movement time T is shorter than the threshold value Ts, it is judged that a fault is present in the ink feed portion 8.

### 5. Notes

The embodiment described above is not meant to limit the scope of the present disclosure, which thus allows for any modifications without departure from the spirit of what is disclosed herein. For example, while in the above embodiment, the torque limiter 73c is provided on the idle gear 73 in the driving mechanism 70 for the piston 882, the torque limiter may also be provided on any other gear (e.g., the driving output gear 74) in the driving mechanism 70.

While the embodiment described above deals with a case in which the sheet S is conveyed while being sucked on the first conveying belt 411 by negative pressure suction, instead, the sheet S may be conveyed while being electrostatically attracted to the electrostatically charged first conveying belt 411 (electrostatic attraction method).

While the embodiment described above deals with an example in which, as the inkjet recording apparatus 1, a color printer that records a color image using four-color ink is used, it is also possible to use the fault check mode according to the embodiment in a monochrome printer that records a monochrome image using only black ink.

The present disclosure is applicable to inkjet recording apparatuses such as inkjet printers.

What is claimed is:

1. An inkjet recording apparatus comprising:
a recording head;
an ink container;
an ink feed portion including:
a subsidiary tank that temporarily stores ink fed from the ink container;
an ink flow passage through which ink circulates from the subsidiary tank through the recording head to the subsidiary tank; and
a syringe pump disposed downstream of the subsidiary tank, upstream of the recording head with respect to an ink flow direction, the syringe pump including a cylinder having at one end a discharge port coupled to the recording head and a loading port coupled to the subsidiary tank and being open at another end, the syringe pump including a piston fitted in the cylinder so as to be movable in one direction toward the one end and in another direction toward the another end;
a driving mechanism that performs a pressing operation to move the piston toward the one end and a pulling operation to move the piston toward the another end;
a timer that counts a movement time of the piston;
a home position detection portion that detects the piston being at a home position; and
a control portion that controls the driving mechanism,
wherein
the driving mechanism has:
a motor;
one or more gears that transmit a driving force of the motor to the piston; and
a torque limiter mounted on one of the gears, and
when the control portion performs a purging operation to forcibly expel ink from a nozzle of the recording head using the syringe pump,
the control portion can execute a fault check mode that performs the pressing operation by pressing the piston at the home position with a previously determined set pressing amount and then, using the timer, counts the movement time after starting the pulling operation until the piston reaches the home position, and
if the movement time is shorter than a threshold value, the control portion detects a fault in the ink feed portion.

2. The inkjet recording apparatus according to claim 1, wherein
the threshold value is determined by calculating a ratio relative to a time required to move the piston pressed with the set pressing amount to the home position by the pulling operation.

3. The inkjet recording apparatus according to claim 1, wherein
the control portion executes the fault check mode when performing the purging operation immediately after replacement or maintenance of the ink feed portion or the recording head.

4. The inkjet recording apparatus according to claim 1, wherein
the control portion executes the fault check mode when performing the purging operation initially after the inkjet recording apparatus has been left unused for a long period.

5. The inkjet recording apparatus according to claim 1, wherein
if, when the control portion executes the fault check mode when performing the purging operation, the movement time is shorter than the threshold value, then only if, when the control portion performs the fault check mode again when performing the purging operation a next time, the movement time is shorter than the threshold value, it is judged that the fault is present in the ink feed portion.

6. The inkjet recording apparatus according to claim 1, further comprising:
a notifying portion that notifies that the fault is present in the ink feed portion,
wherein
the control portion executes the fault check mode, if it is judged that the fault is present in the ink feed portion, the control portion notifies the presence of the fault using the notifying portion.
